(19) United States
(12) Patent Application Publication
(10) Pub. No.: US 2024/0263842 A1
(43) Pub. Date: Aug. 8, 2024

(54) TILT LEG SYSTEM FOR SOLAR PANEL ARRAYS

(71) Applicant: PEGASUS SOLAR, INC., Richmond, CA (US)

(72) Inventor: Erich Kai Stephan, Richmond, CA (US)

(21) Appl. No.: 18/435,927

(22) Filed: Feb. 7, 2024

Related U.S. Application Data
(60) Provisional application No. 63/443,955, filed on Feb. 7, 2023.

(51) Int. Cl. F24S 25/12; H02S 20/24

(52) U.S. Cl. CPC F24S 25/12; H02S 20/24

(57) ABSTRACT

A system to support solar energy modules is described. The system includes an upper tilt leg assembly and a lower tilt leg assembly. The upper tilt leg assembly includes an upper horizontal rail, a support leg, and an upper tilt bracket assembly. The upper bracket assembly may include a lower body pivotally connected to the support leg and an upper body pivotally connected to the upper horizontal rail. The lower body of the tilt bracket may include one or more fasteners and one or more flanges that protrude into the cross-section of the support leg. A method of installing supports for solar energy modules is described. The method includes installing one or more roof attachments onto an installation surface, attaching one or more leg supports to the roof attachments and tilt brackets, and attaching horizontal rails to roof attachments and the tilt brackets.

### CROSS-REFERENCE TO RELATED APPLICATIONS

The present application claims the priority benefit of U.S. Provisional Patent Application No. 63/443,955 filed on Feb. 7, 2023 and entitled “Tilt Leg System for Solar Panel Arrays,” the disclosure of which is incorporated herein by reference in its entirety.

### BACKGROUND OF THE INVENTION

### 1. Field of the Disclosure

The present disclosure is generally related to the installation of solar panels.

### 2. Description of the Related Art.

When installing a solar array on a flat rooftop, often a series of beams (commonly known as rails) that support the solar panels are installed at two different heights to angle an installed solar panel relative to the roof surface using a pair of support legs in conjunction with an additional set of structural legs. Some current installation systems further require more than one pair of beams to install and support solar panels at an angle.

Angling of the solar panel array aids in converting more sunlight into energy than an array installed flat or parallel with a flat roof surface when installed away from the Earth's equator. Requiring an additional beam or set of structural legs adds cost and complexity to both the installation, distribution, and manufacturing of rooftop solar arrays. Thus, there is a need for streamlined installation of angled solar panels.

### SUMMARY OF THE CLAIMED INVENTION

Embodiments of the present invention include systems to support solar energy modules is described. The system may include a pair of support assemblies, including an upper tilt leg assembly configured to be positioned along an upper half of a solar module and a lower tilt leg assembly configured to be positioned along a lower half of a solar module. The upper tilt leg assembly may include an upper horizontal rail, a support leg, and an upper tilt bracket assembly. The upper bracket assembly may include a lower body pivotally connected to the support leg and an upper body pivotally connected to the upper horizontal rail. The lower body of the tilt bracket may include one or more fasteners and one or more flanges that protrude into the cross-section of the support leg.

Various embodiments of the present invention may further include methods of installing supports for solar energy modules. The methods may include installing one or more roof attachments onto an installation surface, attaching one or more leg supports to the roof attachments and tilt brackets, and attaching horizontal rails to roof attachments and the tilt brackets.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIGS. 1A and 1B depict isometric views of an exemplary tilt leg system.

FIG. 2 is a close-up isometric view of an exemplary upper tilt leg assembly.

FIGS. 3A and 3B depict a front and back side of an exemplary upper tilt bracket.

FIGS. 4A and 4B depict an isometric and top-down view of an exemplary L-foot.

FIG. 5 depicts an isometric view of an exemplary rail bracket installed onto a rail section.

FIGS. 6A through 6C depict side views of various exemplary installation configurations.

FIGS. 7A through 7B depict an alternative embodiment of an exemplary upper tilt bracket.

FIGS. 8A and 8B depict isometric views of an exemplary fixed upper plate alone and with fixed upper plate installed onto a rail section.

FIGS. 9A and 9B are close-up isometric views depicting an exemplary lower tilt leg assembly.

FIG. 10 depicts an exemplary lower tilt leg assembly in a folded configuration.

FIGS. 11A through 11D depict steps in an exemplary method of installing a tilt leg system.

### DETAILED DESCRIPTION

The present invention streamlines and reduces the total costs of installing solar on a flat roof surface by re-using the same rail profile from the support rails in the structural legs. Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

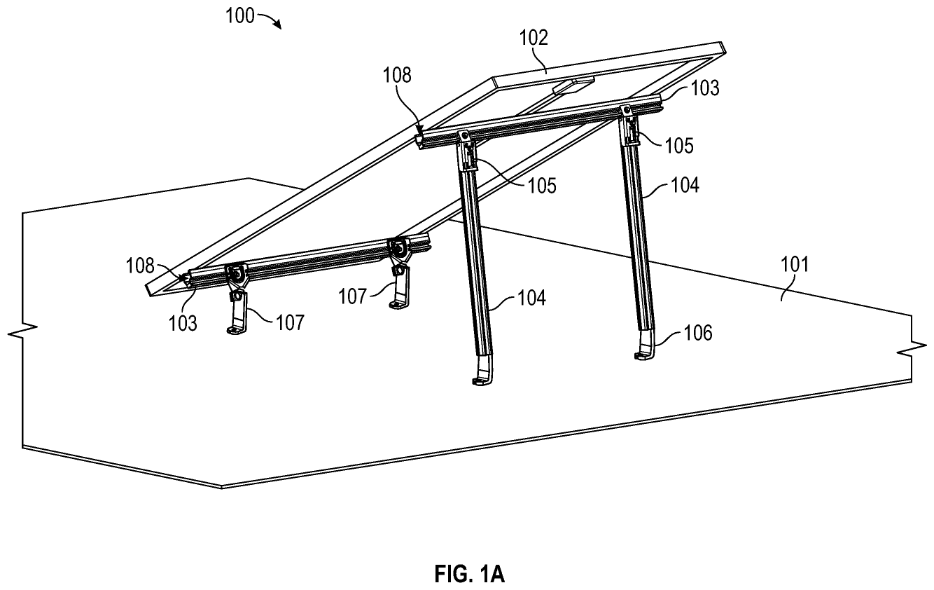

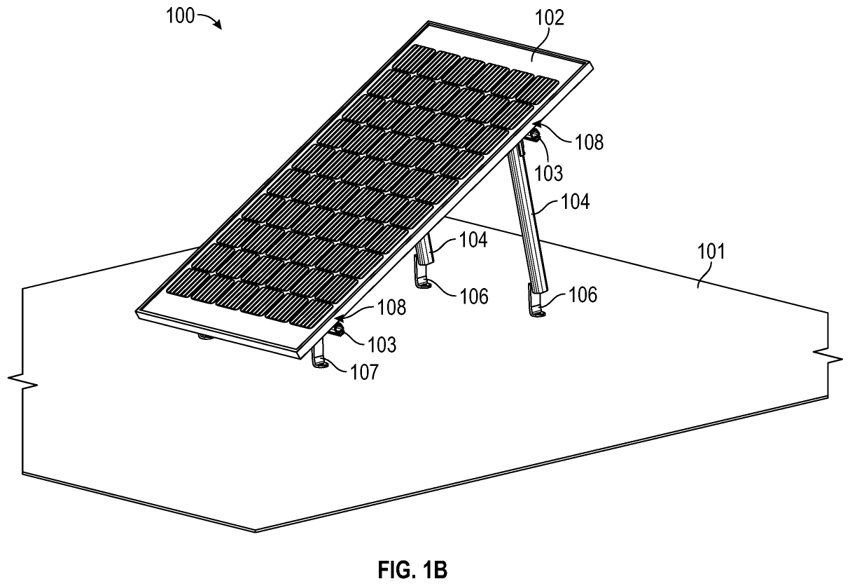

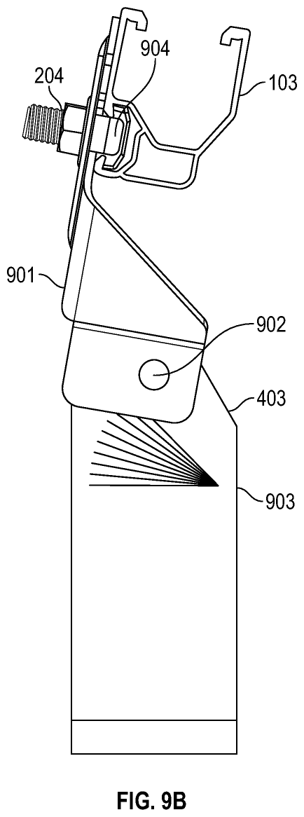

FIGS. 1A and 1B depict isometric views of present invention. FIG. 1A depicts an isometric view showing the back side of the tilt system 100, whereas FIG. 1B depicts an isometric view showing the front side of the tilt system 100. Solar energy module 102 may be secured to a pair of rails 103, which may include a lower horizontal rail and an upper horizontal rail, by one or more panel clamps 108. The upper horizontal rail may be configured to be placed along an interior portion of an upper half of the solar module that is tilted away relative to an installation surface, while the lower horizontal rail may be configured to be placed proximate to a lower half of the solar module that is closer to the installation surface. Rails 103 may have substantially U-shaped cross section. One or more lower tilt assemblies 107 are secured to a roof surface 101 (or installation surface) using one or more fasteners. The lower tilt assembly 107 is attached to a first rail 103, or lower horizontal rail. The first rail 103 may be placed along an interior portion of lower half of the solar energy module 102, close to the roof surface. An upper tilt bracket assembly 105 is attached to a second rail 103, or upper horizontal rail, by an opposite half of the solar energy module 102 angled up from the roof surface on the upper side of the solar energy module 102. The upper tilt bracket assembly 105 is also attached to a first end of a rail section 104, or a support leg section. Rail section 104 may have the same cross-sectional shape as rail 103. In some cases, upper tilt bracket assembly 105 may be referred to as the first bracket assembly. A second end of rail section 104 is attached to a L-foot 106, or upper roof attachments, and the L-foot 106 is secured to a roof surface roof surface 101 by one or more fasteners. Solar energy module 102 may be a solar photovoltaic panel, a solar water thermal panel, or any other solar energy collecting device. In some cases, rail 103, upper tilt bracket assembly 105, and rail section 104 may be referred to as a first support assembly. In some cases, rail 103 and lower tilt assemblies 107, or rail 103 and lower tilt bracket 901 (illustrated in FIG. 9A) may be referred to as a second support assembly.

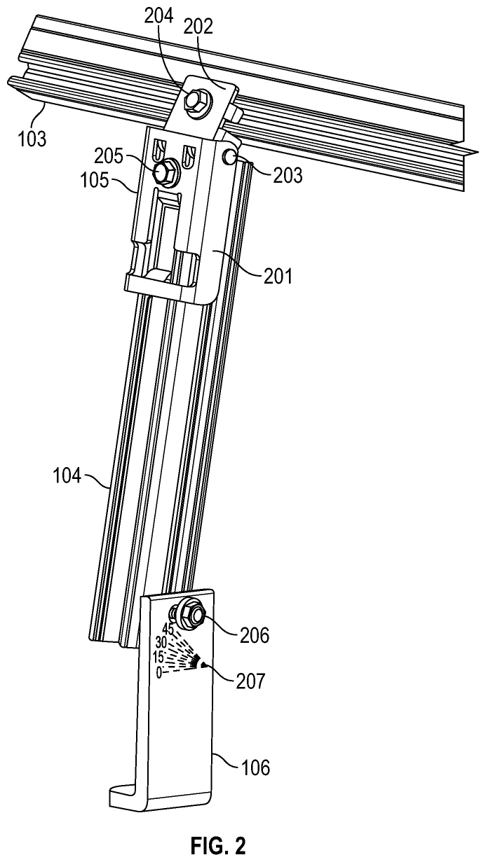

FIG. 2 is a close-up isometric view of the upper tilt leg assembly, with the solar energy module 102 and panel clamps 108 removed for ease of depiction. The upper tilt bracket assembly 105 may include a rail bracket 201, or lower portion of the upper tilt bracket assembly 105, and a swivel bracket 202, or upper portion of the upper tilt assembly 105. In some cases, rail bracket 201 may be referred to as a first body of the upper tilt bracket assembly 105 and swivel bracket 202 may be referred to as a second body of the upper tilt bracket assembly 105. The rail bracket 201 may have a top surface and one or more side surfaces that extend and angle away from the top surface of the rail bracket 201. The rail bracket 201 may further be connected to rail section 104. The swivel bracket 202 may have a main surface and one or more side surfaces that extend and angle away from the main surface of the swivel bracket 202. The swivel bracket 202 may further be connected to rail 103.

The rail bracket 201 and the swivel bracket 202 may be pivotally connected by one or more fasteners 203. The fasteners 203 may be placed on side surfaces of the rail bracket 201. The fasteners 203 may join the side surfaces of the rail bracket 201 to the side surfaces of the swivel bracket 202. The fasteners 203 may be a threaded fastener, a rivet, a pin, a flange bent from the rail bracket 201, or some other piece suitable to mechanically secure the swivel bracket 202 to the rail bracket 201 while allowing rotation around the axis of the fasteners 203. Fasteners 203 may also provide an electrical bonding connection between swivel bracket 202 and rail bracket 201. Further, rail bracket 201 and swivel bracket 202 may electrically bond rail section 104 to rail 103. Swivel bracket 202 may rotate around the axis of fasteners 203 relative to the main body of rail bracket 201 from a position relatively co-planar to rail bracket 201 to 180 or more degrees. Swivel bracket 202 may connect with rail 103 using a rail fastener 204. As such, the rail bracket 201 and swivel bracket 202, or the upper tilt bracket assembly 105, allow the rail section 104 to pivot relative to rail 103.

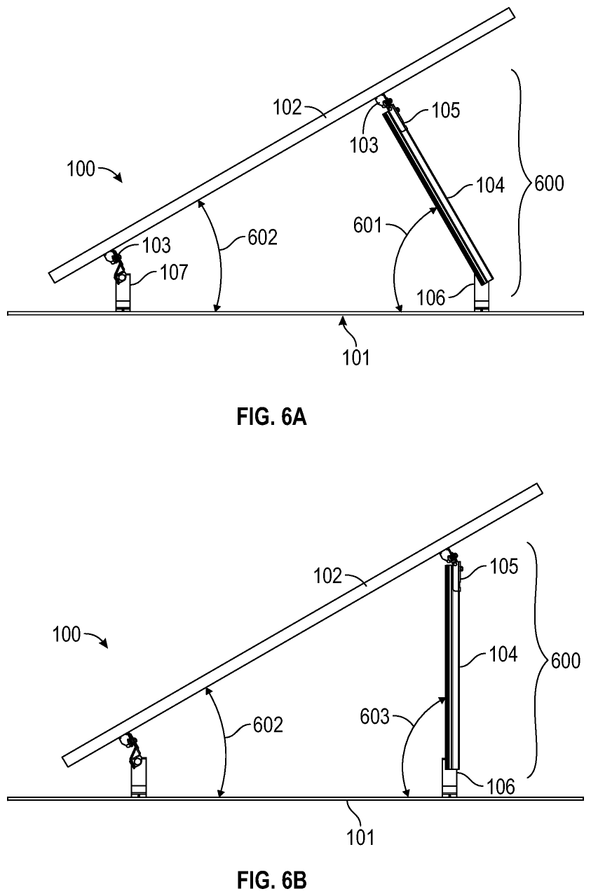

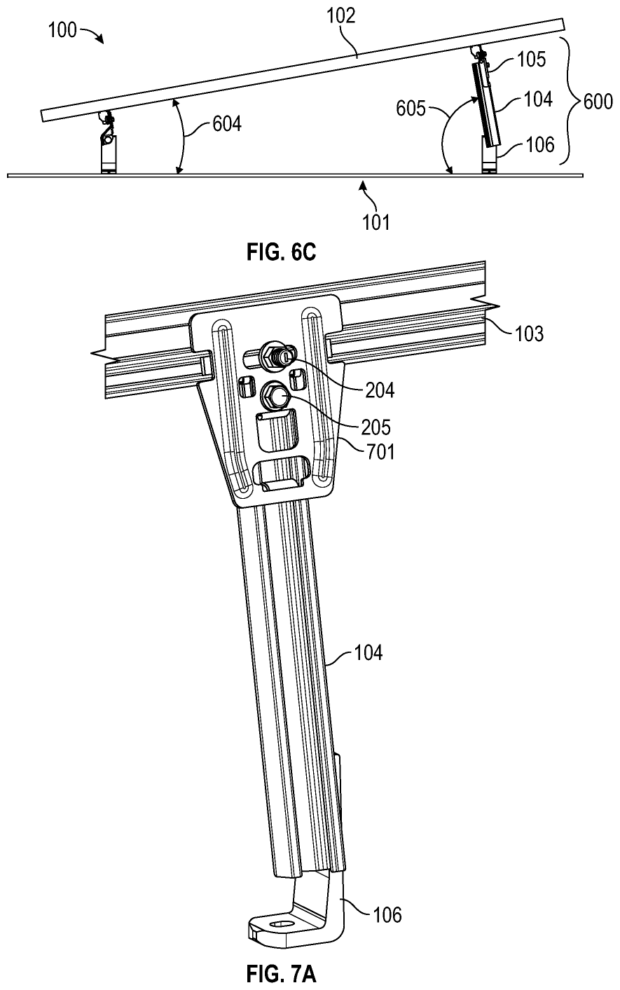

Rail bracket 201 may have a rail section fastener 205 disposed on the top surface of the rail bracket 201. The rail bracket 201 may extend into a primary channel of the rail section 104. A L-foot 106 may have an aperture through which another rail fastener 204 disposed to connect to a lower end of the rail section 104. An angle indicator 207 may be disposed on one or more surfaces of L-foot 106. The angle indicator 207 may have several lines indicating an angle relative to the body of the L-foot 106. The angle indicator 207 may indicate or aid in the calculation of the angle between a surface of rail section 104 relative to a surface of L-foot 106, such as angle 601, angle 603, or angle 605 as illustrated in FIGS. 6A, 6B, and 6C.

Rail bracket 201 may have a substantially uniform wall thickness, and swivel bracket 202 may have a substantially uniform wall thickness. Rail bracket 201 and swivel bracket 202 may be manufactured using one or more processes of stamping, progressive die stamping, cutting and bending, machining, extrusions, casting, or other suitable process. Rail bracket 201 and swivel bracket 202 may be made from aluminum, steel, stainless steel, a polymer, glass-filled resin, or other suitable material. L-foot 106 may have a uniform cross-section along one dimension, except for one or more apertures and corner radii. For example, L-foot 106 may be manufactured with a uniform cross-section in a first step, then cut to a desired length, and then one or more apertures or edge shapes removed perpendicular to the uniform cross-section dimension.

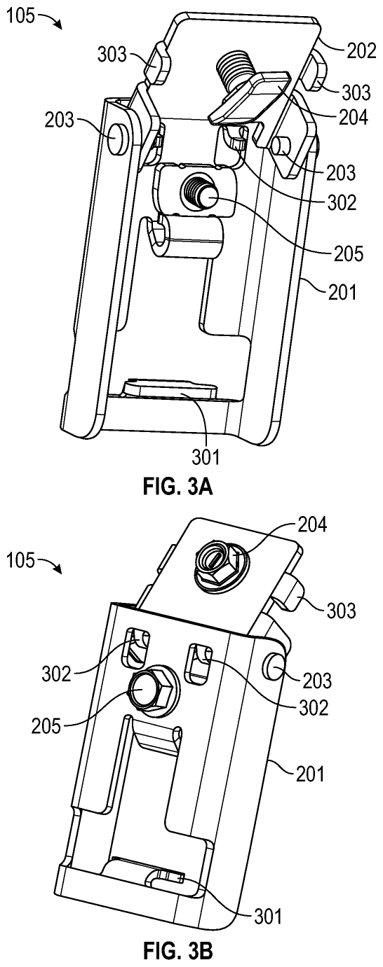

FIGS. 3A and 3B depict a front and back side of an upper tilt bracket assembly 105. As depicted, the swivel bracket 202, is at an angle relative to the main body of rail bracket 201. One or more rail tabs 303 may extend from one or more edges of the main surface of the swivel bracket 202 and extend at an angle away from the plane of the main surface into a groove disposed on the side of the rail 103, each rail tab protruding into different points in the groove. The rail tabs 303 may be substantially aligned with rail fastener 204 such that the rail tabs 303 and rail fastener 204 protrude into the groove. In other embodiments not shown, the rail fastener 204 may instead be a single or two-piece clamp design to grip onto a rail 103. In this example, the rail tabs 303 may extend below a lower surface of fasteners 203. In both cases, the rail tabs 303 may prevent the swivel bracket 202 from rotating axially around rail fastener 204 relative to rail 103.

In one example embodiment of the present invention, a distal end of the rail fastener 204 has a T-shaped head where the head is insertable to a groove on a rail 103 and upon rotating to a suitable angle, the head is captured within the groove. As depicted, the fasteners 203 may extend just beyond the inner wall of the body of swivel bracket 202. In other embodiments, a single fastener 203 may span the entire width of a side surface of rail bracket 201. One or more stop flanges 302 may protrude from the top surface of rail bracket 201 into one or more cutouts on the top surface of rail bracket 201. The one or more flanges 302 may protrude into the underside of rail bracket 201 at an upper portion of the top surface of the rail bracket 201. A securement flange 301 may extend from the top surface of rail bracket 201 and angle away into a cutout on the top surface of rail bracket 201. The securement flange 301 may be positioned at a lower distal portion of the rail bracket 201 and protrude into the underside space of the rail bracket 201. The securement flange 301 may be configured to slide into a primary channel of the rail section 104 and extend under one or more flanges on the distal ends of the primary channel on the rail section 104. A rail section fastener 205 may threadably engage onto a nut. The securement flange 301 and the one or more stop flanges 302 may be formed from the body of rail bracket 201.

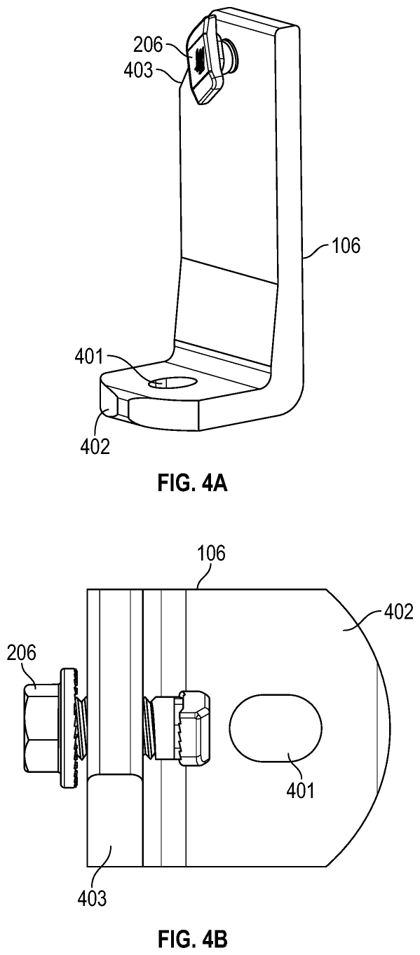

FIGS. 4A and 4B depict an isometric and top-down view of L-foot 106. At an upper portion of L-foot 106 a rail fastener 206 may be disposed through an aperture. One or more chamfers 403 may be disposed at a distal top end of L-foot 106. An aperture 401 may be disposed on a lower flange of L-foot 106. A radius or chamfer 402 may define an outside perimeter dimension on the distal edge of the lower flange of L-foot 106. The chamfer 402 may be configured to allow the L-foot 106 to fit inside a tube or hole smaller than if the chamfer 402 were not present, such as a 3 inch diameter circular tube. As depicted, L-foot 106 may have a thicker cross-section near the lower flange compared to the distal end.

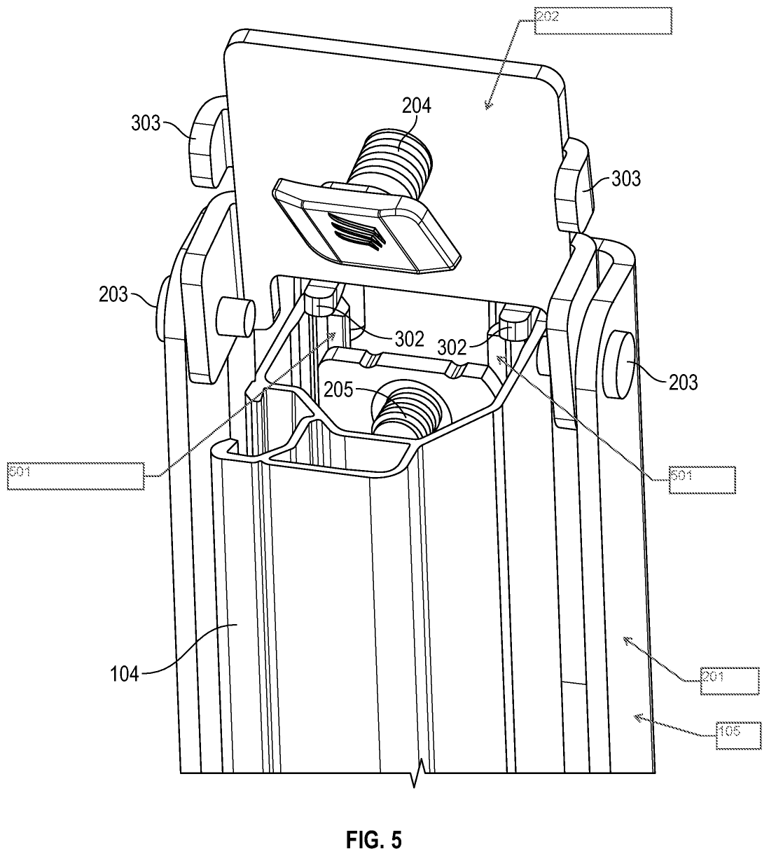

FIG. 5 depicts an isometric view of rail bracket 201 installed onto rail section 104. The one or more stop flanges 302 abut to the end of the distal end surface of rail section 104 to prevent the rail bracket 201 sliding further onto rail section 104. As shown, the rail section fastener 205 resides inside the open channel of rail section 104 and underneath one or more inwardly protruding rail flanges 501. The fasteners 203 extend through both the rail bracket 201 and swivel bracket 202 on either side, but not so far as to interfere with rail section 104. As shown and in this state, the rail bracket 201 may be affixed to rail section 104 after rail section fastener 205 is tightened, yet the swivel bracket 202 may pivotally rotate around the axis of fasteners 203 relative to rail section 104 and rail bracket 201.

FIGS. 6A through 6C depict side views of various installation configurations representing one example of the present invention. In FIG. 6A, tilt system 100 consists of solar energy module 102 secured to rail 103 through one or more clamps (not shown). solar energy module 102 forms a tilt angle 602 relative to the roof surface 101. In this example, rail section 104 is at an angle 601 relative to the roof surface 101 such that rail section 104 is substantially perpendicular to solar energy module 102. In this configuration, rail bracket 201 and swivel bracket 202 of upper tilt bracket assembly 105 would also be substantially planar to one another.

FIG. 6B depicts an alternative embodiment of FIG. 6A, wherein tilt angle 602 is the same value as FIG. 6A. However, rail bracket 201 of upper tilt bracket assembly 105 has pivotally rotated with swivel bracket 202 of upper tilt bracket assembly 105 such that rail section 104 is now substantially perpendicular to roof surface 101, or angle 601 is now instead a substantially right angle 603. In these two cases, in order for tilt angle 602 to remain a constant value, rail section 104 may be cut to a different length, the distance between lower tilt assembly 107 and L-foot 106 may become shorter or longer, or the location at which rail section 104 is secured to L-foot 106 along the length of rail section 104 may be different.

FIG. 6C depicts yet another example configuration of the present invention. In this example embodiment, tilt angle 602 is now at a lower tilt angle 604 by the function of a shorter rail section 104. Rail section 104 may be cut at a specific length to support the solar energy module 102 at the lower tilt angle 604.

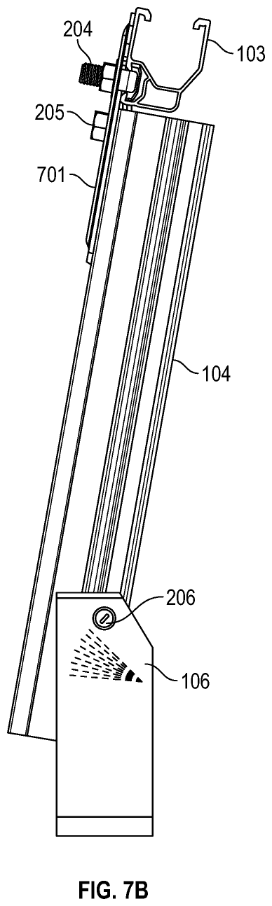

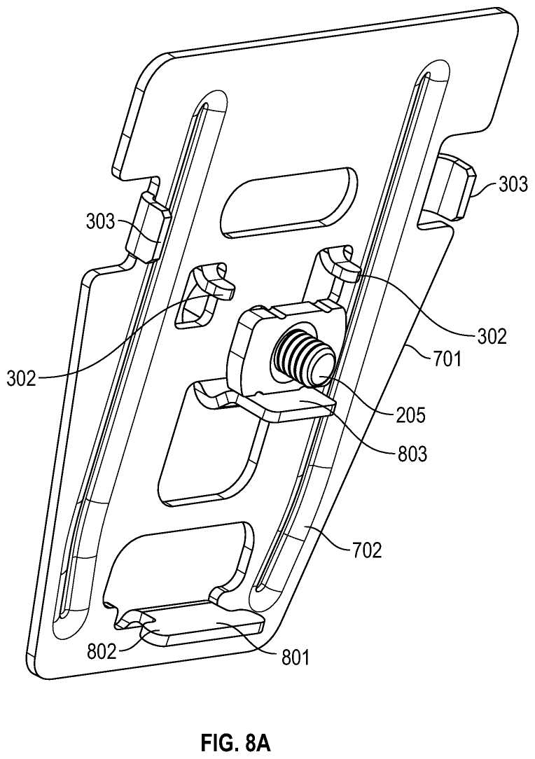

FIGS. 7A through 7B depict an alternative embodiment of upper tilt bracket assembly 105, wherein upper tilt bracket assembly 105 is constructed of a single fixed upper plate 701 without any pivotal connections. In other words, rail bracket 201 and swivel bracket 202 are fabricated as a single component. In this example embodiment, fixed upper plate 701 still employs the rail section fastener 205 to secure to rail section 104, and the rail fastener 204 to secure rail 103. FIG. 7B is a side angle of 7A, demonstrating the planar geometry of fixed upper plate 701. fixed upper plate 701 may secure rail section 104 and rail 103 so that rail section 104 would be substantially perpendicular to a solar energy module 102 (not shown) upon installation.

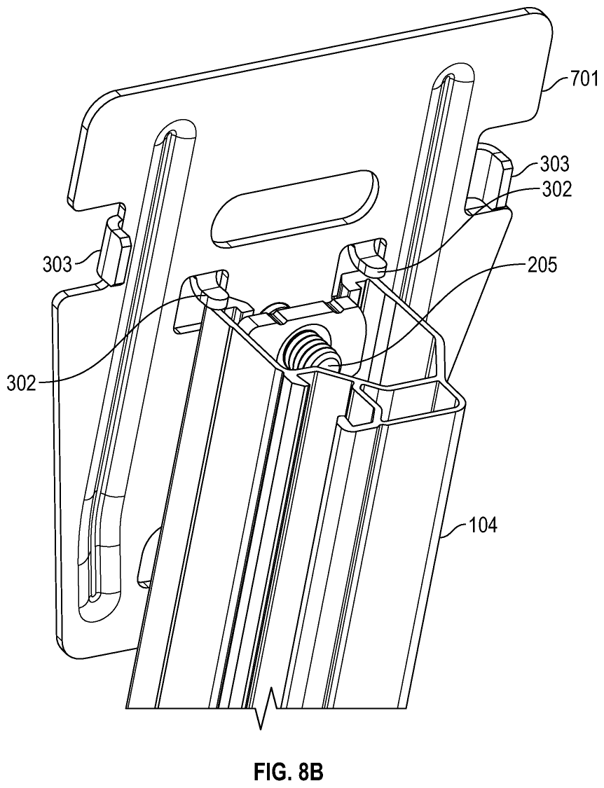

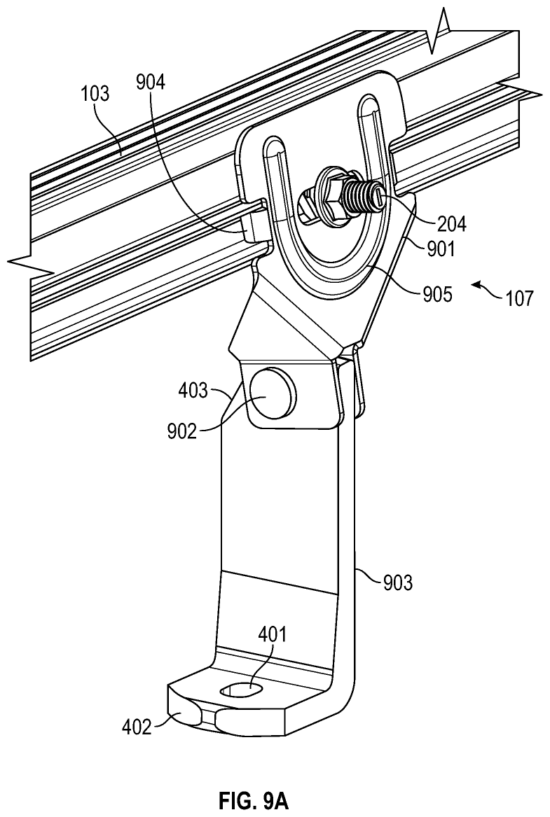

FIGS. 8A and 8B depict isometric views of fixed upper plate 701 alone and with fixed upper plate 701 installed onto a rail section 104. In FIG. 8A, fixed upper plate 701 has one or more rail tabs 303 and stop flanges 302 extending away from the main body. In some cases, rail tabs 303 may be referred to as side-stiffening flanges. The rail tabs 303 and stop flanges 302 may be formed from the body of fixed upper plate 701. A nut capture flange 803 may be formed from the body of fixed upper plate 701 and positioned so the width of 803 prevents a nut on rail section fastener 205 from substantially rotating when the bolt of rail section fastener 205 is rotated about its primary axis. Fixed upper plate 701 may have one or more ribs 702 extending fully or partially along the length of fixed upper plate 701 that indents into fixed upper plate 701 to increase the flexural strength and moment of inertia of fixed upper plate 701. One or more rail capture flanges 801 may extend away from the body of fixed upper plate 701 substantially perpendicular to the body of fixed upper plate 701. On either side of rail capture flanges 801, one or more capture tabs 802 may extend laterally. Capture tabs 802 may be wide enough to extend under inwardly protruding rail flanges 501 upon installing into a rail section 104. FIG. 8B depicts fixed upper plate 701 installed onto a rail section 104. In this example embodiment, the stop flanges 302 abut the end face of rail section 104 to prevent fixed upper plate 701 from sliding farther down the rail section 104.

FIGS. 9A and 9B are close-up isometric views depicting a lower tilt assembly 107. Lower tilt assembly 107 may consist of a lower tilt bracket 901, a lower L-foot 903, a square-step fastener 902, and a rail fastener 204. In some cases, a lower tilt assembly 107 may be referred to as the roof attachment bracket. In some other cases, lower L-foot 903 may be referred to as the roof attachment bracket. As shown, the L-foot 903, or lower roof attachment, may be the exact same component as L-foot 106. Lower tilt bracket 901 may have a main surface planar to the length of rail 103 and one or more side surfaces that extend from the main surface that angles away from the main surface. Lower tilt bracket 901 may have one or more ribs 905 that protrude away from the side of lower tilt bracket 901 that a rail 103 attaches onto. Ribs 905 may protrude out away from the rail 103 in a U-shape around rail fastener 204. Ribs 905 may increase the moment of inertia of the lower tilt bracket 901 to improve its strength against plastically or permanently bending. Lower tilt bracket 901 may have one or more rail groove flanges 904 that protrude from the main body of lower tilt bracket 901 towards the rail 103. As depicted, the 904 may extend into a groove of rail 103. In other example embodiments, the 904 may extend below the lower surface of rail 103. The rail groove flanges 904 may be configured to substantially prevent the lower tilt assembly 107 from rotating around the primary axis of rail fastener 204 when lower tilt assembly 107 is affixed to rail 103.

Lower tilt bracket 901 may be pivotally connected to lower L-foot 903 by a square-step fastener 902. Square step fastener 902 may be placed on a side surface of the main surface of lower tilt bracket 901. The angle at which lower tilt bracket 901 and lower L-foot 903 align may be adjusted by square-step fastener 902 as illustrated in FIG. 9B. An angle indicator may be disposed on one or more surfaces of lower L-foot 903. The angle indicator may have several lines indicating an angle of a surface of lower tilt bracket 901 relative to the body of the lower L-foot 903. The angle indicator may indicate the angle at which a surface of lower tilt bracket 901 tilts from a surface of L-foot 903 or from the roof surface. The angle indicator may indicate or aid in calculation of tilt angle 602 as illustrated in FIGS. 6A, 6B, and 6C. Square-step fastener 902 may be a stainless steel, carbon steel, metal, aluminum, or other suitable material. square-step fastener 902 may have a square shank section configured to engage with flat portions of an aperture in L-foot 903. The square shank sections would substantially prevent the square-step fastener 902 from rotating when a nut is rotated, or the lower tilt bracket 901 is rotated relative to L-foot 903.

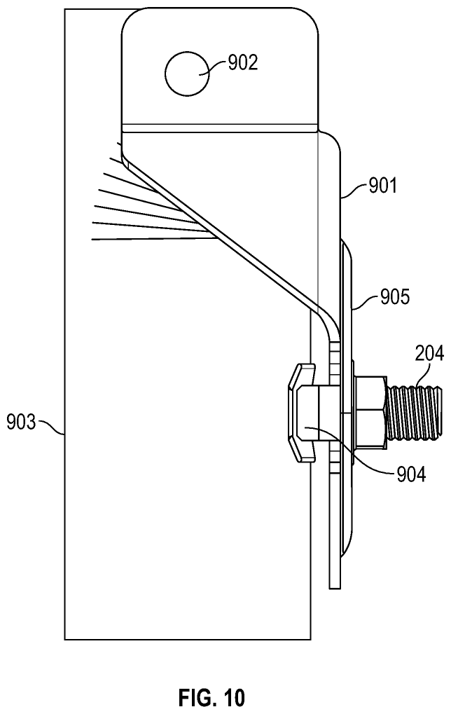

FIG. 10 depicts a lower tilt assembly 107 in a folded configuration, such as when packaged for shipping. As illustrated, lower tilt bracket 901 may pivot about square-step fastener 902 such that the body of lower tilt bracket 901 overlaps the lower L-foot 903. The side surfaces of main surface of lower tilt bracket 901 may be distanced apart at a distance of the width of the lower L-foot 903 to allow the rotation of tilt bracket 901 up to 180 degrees from the installation position relative to the L-foot 903.

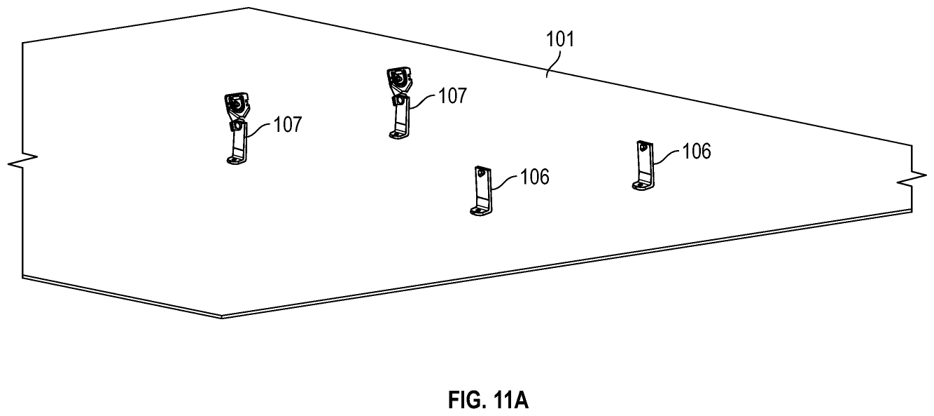

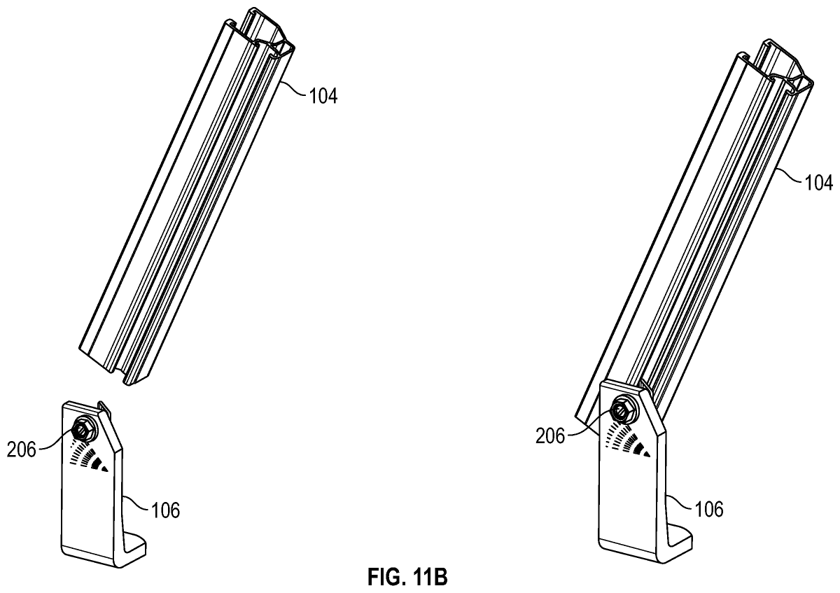

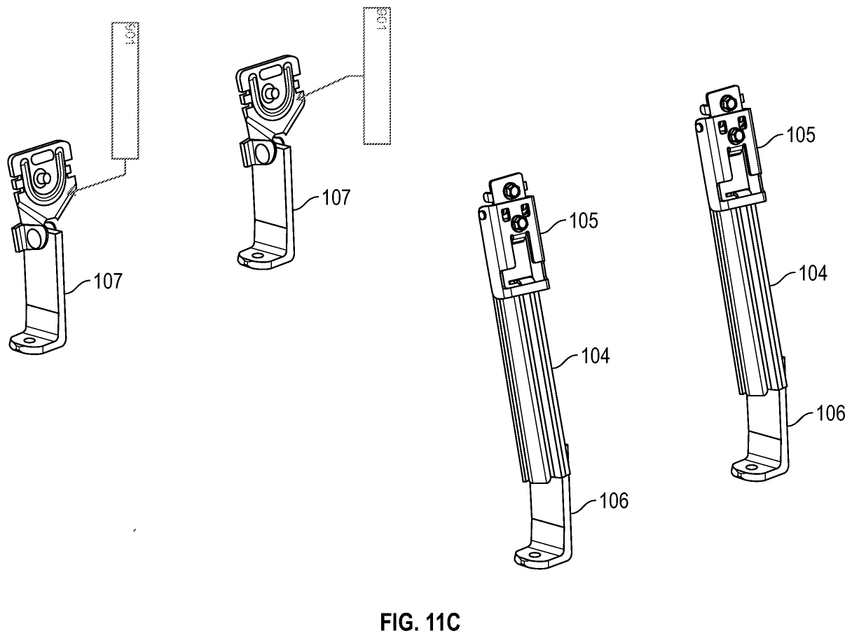

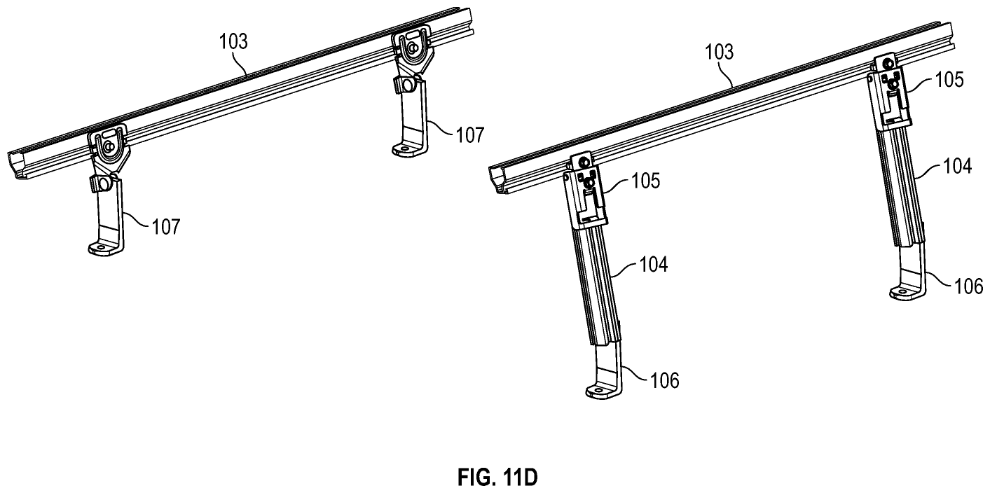

FIGS. 11A through 11D depict an example method of installing the present invention. In FIG. 11A, one or more L-foots 106, or upper roof attachments, are installed on a roof surface 101 (installation surface) and one or more lower tilt assembly 107 (lower roof attachments) are installed on a roof surface 101. In an embodiment, the lower tilt bracket 901 is attached to lower L-foot 903 prior to installation of tilt assembly 107 to the roof surface. In another embodiment, the lower L-foot 903 of the lower tilt assembly 107 is installed to the roof surface 101 then the lower tilt bracket 901 is attached to the lower L-foot 903. The primary vertical flat surface of L-foot 106 and L-foot 903 may be substantially co-planar, as depicted, or they may not be co-planar. Likewise, the secondary vertical flat surface of L-foot 106 and a second L-foot 106 may be substantially co-planar, as depicted, or they may not be co-planar.

FIG. 11B depicts another step where one or more rail sections 104, or leg supports, are aligned and secured to a L-foot 106 using a rail fastener 206. Each rail section 104 may be attached to L-foot 106 at the distal, bottom end of rail section 104. Rail section 104 may be attached to L-foot 106 at a desired angle (for example, angles 601, 603, or 603 in FIGS. 6A, 6B, 6C) away from the horizontal plane of L-foot 106 rotated about rail fastener 206 as indicated by the angle indicator 207. The rail section 104 may be cut from the same beam that is used for rail 103, such that the beam, rail 103, and rail section 104 may have the same cross section. In an embodiment, the rail 103 is substantially U-shaped.

FIG. 11C depicts an upper tilt bracket assembly 105 installed onto a rail section 104 at a distal top end of rail section 104. A lower tilt bracket 901 of lower tilt assembly 107 may be attached to lower L-foot 903 of lower tilt assembly 107, rotated at an installation angle relative to L-foot 903 (for example, angles 602 and 604 in FIGS. 6A, 6B, 6C).

FIG. 11D depicts another step where a rail 103 is installed to one or more lower tilt assembly 107, and a second rail 103 is installed to one or more upper tilt bracket assembly 105. For example, the lower tilt bracket 901 of lower tilt assembly 107 maybe attached to rail 103. The second rail 103 may be articulated around the rail fastener 204 of the swivel bracket 202 or the fastener 203 of the upper tilt bracket 105 to ensure alignment of the rail 103 and the second rail 103. The rails 103 may be secured to solar module 102 by one or more clamps 108. It is anticipated that the order of installation steps shown in FIGS. 11A through 11D may occur in any sequence. In some example methods, an upper tilt bracket assembly 105 may be installed to a rail section 104 and a rail 103 before the rail section 104 is installed to the L-foot 106.

What is claimed is:

1. A system to support solar modules, the system comprising:
a first support assembly configured to support a solar module, wherein the first support assembly includes:
a first horizontal rail configured to extend along a first half of the solar module,
a support leg, wherein the support leg has a same cross-sectional shape as the first horizontal rail, and
a first bracket assembly configured to connect the support leg to the first horizontal rail; and
a second support assembly configured to support the solar module along a second half opposite the first half, wherein the second support assembly includes a second horizontal rail configured to extend along the second half of the solar module.

2. The system of claim 1, wherein the second support assembly further includes a second bracket configured to connect to the second horizontal rail.

3. The system of claim 2, wherein the second bracket is pivotally connected to a roof attachment bracket.

4. The system of claim 1, wherein the support leg is cut at a specific length to achieve a corresponding tilt angle of the solar module from an installation surface while the solar module is supported by the first support assembly.

5. The system of claim 1, further comprising one or more clamps that attach the solar module to the first horizontal rail or the second horizontal rail.

6. The system of claim 1, further comprising an L-foot that secures the support leg to an installation surface.

7. The system of claim 1, wherein the first support assembly further includes:
a rail bracket; and
a swivel bracket pivotally connected to the rail bracket by one or more fasteners.

8. The system of claim 7, wherein the rail bracket is further connected to the support leg to allow the support leg to pivot relative to the first horizontal rail.

9. The system of claim 7, wherein the rail bracket includes one or more stop flanges that extend at an angle away from a top surface of the rail bracket.

10. The system of claim 1, wherein one or more of the first horizontal rail and the second horizontal rail are substantially U-shaped.

11. A tilt bracket apparatus comprising:
a first body configured to pivotally connect to a support leg; and
a second body configured to pivotally connect to a horizontal rail that has a same cross-sectional shape as the support leg, wherein the horizontal rail is capable of rotating relative to the support leg at a pivotal axis when the first body is connected to the support leg and the second body is connected to the horizontal rail.

12. The apparatus of claim 11, wherein the first body includes one or more fasteners that secures the support leg within a channel of a cross-section of the support leg.

13. The apparatus of claim 11, wherein the first body includes one or more securement flanges configured to be slid into a channel of a cross-section of the support leg.

14. The apparatus of claim 11, wherein the first body further includes one or more side-stiffening flanges extending away from one or more edges of a top surface of the first body.

15. The apparatus of claim 11, further comprising a rivet that connects the first body to the second body.

16. The apparatus of claim 11, wherein one or more of the first body and the second body electrically bonds the support leg to the horizontal rail.

17. A method of installing supports for solar energy modules, the method comprising:
attaching a first set of one or more tilt brackets to a first end of each of one or more support legs;
attaching a second end of each of the one or more support legs to a first set of one or more roof attachments, wherein the first set of roof attachments is secured to an installation surface;
attaching a first horizontal rail to the first set of tilt brackets, the first horizontal rail configured to extend along a first half of a solar module; and
attaching a second horizontal rail to a second set of tilt brackets, the second horizontal rail configured to extend along a second half of a solar module opposite the first half, the second set of one or more tilt brackets attached to a second set of roof attachments secured to the installation surface.

18. The method of claim 17, further comprising articulating the first horizontal rail around a pivot point in the first set of tilt brackets to place the first horizontal rail in parallel with the second horizontal rail.

19. The method of claim 17, further comprising securing the solar module to the first horizontal rail along the first half and to the second horizontal rail along the second half opposite the first half, wherein securing the solar module includes using one or more clamps.

20. The method of claim 17, wherein the first set of one or more tilt brackets are configured differently from the second set of one or more tilt brackets.

21. A method of installing supports for solar energy modules, the method comprising:
cutting a beam having a cross-section into a plurality of sections, wherein the sections include a first horizontal rail, a second horizontal rail, and one or more support legs;
attaching a first set of one or more tilt brackets to a first end of each of the support legs;
attaching a second end of each of one or more support legs at a respective first set of one or more roof attachments, wherein the first set of roof attachments are secured to an installation surface;
attaching a first horizontal rail to the first set of tilt brackets, the first horizontal rail configured to extend along a first half of a solar module;
attaching a second horizontal rail to a second set of tilt brackets, the second horizontal rail configured to extend along a second half of a solar module opposite the first half, the second set of one or more tilt brackets attached to a second set of roof attachments secured to the installation surface.

22. The method of claim 21, further comprising articulating the first horizontal rail around a pivot point in the first set of tilt brackets to place the first horizontal rail in parallel with the second horizontal rail.

23. The method of claim 21, further comprising securing the solar module using one or more clamps to the first horizontal rail along the first half and to the second horizontal rail along the second half opposite the first half.

24. The method of claim 21, wherein the first set of one or more tilt brackets are configured differently from the second set of one or more tilt brackets.
